(19) United States
(12) Patent Application Publication
(10) Pub. No.: US 2015/0041613 A1
(43) Pub. Date: Feb. 12, 2015

(54) Tree Stand Device

(71) Applicant: Mario M. Ray, Collierville, TN (US)

(72) Inventor: Mario M. Ray, Collierville, TN (US)

(21) Appl. No.: 13/960,565

(22) Filed: Aug. 6, 2013

(51) Int. Cl. A47G 33/12; F16M 11/28; E04H 12/22

(52) U.S. Cl. CPC A47G 33/12; E04H 12/2246; F16M 11/28
USPC 248/523; 248/519

(57) ABSTRACT

A tree stand device supports and holds a tree in an upright position. The device includes a first sleeve having a top end and a bottom end. A second sleeve is extendably nested in the first sleeve and extendable from the top end of the first sleeve. The first sleeve and the second sleeve define a telescopically extendable tube configured for receiving a trunk of a tree. A locking member coupled to the first sleeve selectively engages the second sleeve wherein the second sleeve is held in a static position relative to the first sleeve. Each of a plurality of legs is coupled to and extends from first sleeve. The legs are positioned proximate the bottom end of the first sleeve supporting the tube in an upright position.

### BACKGROUND OF THE DISCLOSURE

### Field of the Disclosure

The disclosure relates to stand devices and more particularly pertains to a new stand device for supporting and holding a tree in an upright position.

### SUMMARY OF THE DISCLOSURE

An embodiment of the disclosure meets the needs presented above by generally comprising a first sleeve having a top end and a bottom end, A second sleeve is extendably nested in the first sleeve and extendable from the top end of the first sleeve. The first sleeve and the second sleeve define a telescopically extendable tube configured for receiving a trunk of a tree. A locking member coupled to the first sleeve selectively engages the second sleeve wherein the second sleeve is held in a static position relative to the first sleeve. Each of a plurality of legs is coupled to and extends from first sleeve. The legs are positioned proximate the bottom end of the first sleeve supporting the tube in an upright position.

There has thus been outlined, rather broadly, the more important features of the disclosure in order that the detailed description thereof that follows may he better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein

FIG. 1 is a top front side perspective view of a tree stand device according to an embodiment of the disclosure,

FIG. 2 is a front view of an embodiment of the disclosure.

FIG. 3 is a cross-sectional view of an embodiment of the disclosure taken along line 3-3 of FIG. 2.

FIG. 4 is a top view of an embodiment of the disclosure.

FIG. 5 is a side view of an embodiment of the disclosure in use.

FIG. 6 is a side view of an alternate embodiment of the disclosure in use.

### DESCRIPTION OF THE PREFERRED EMBODIMENT

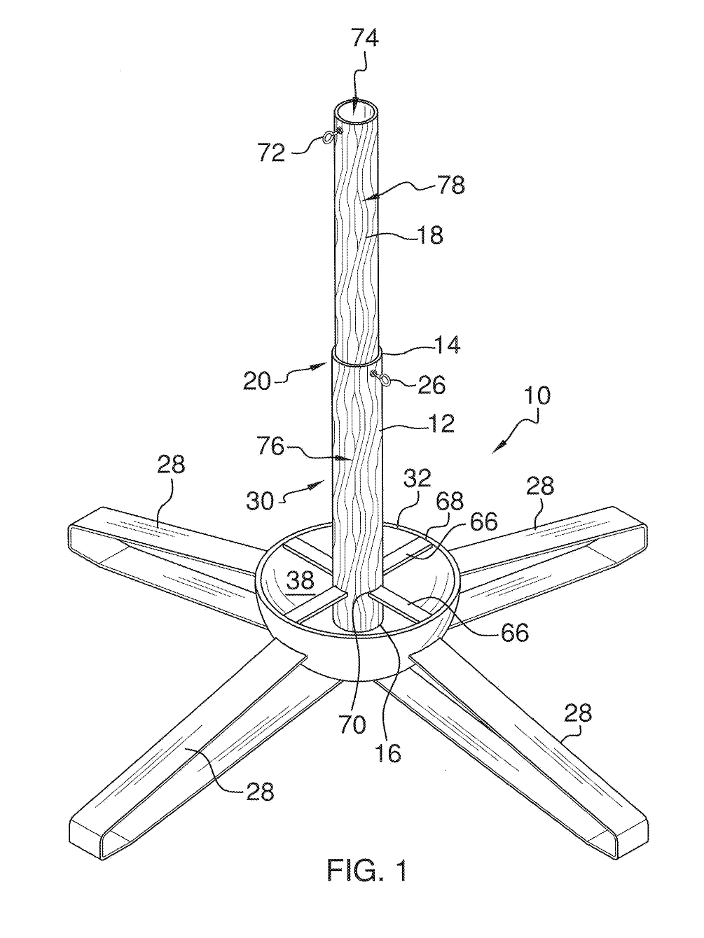

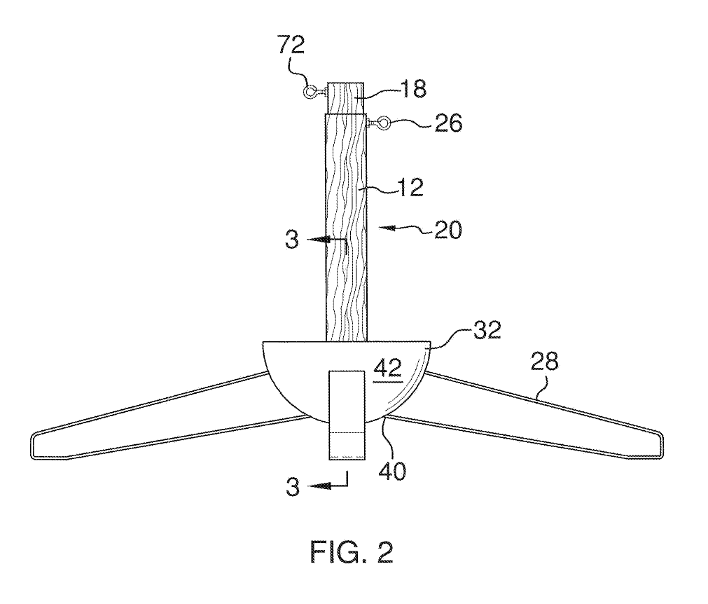

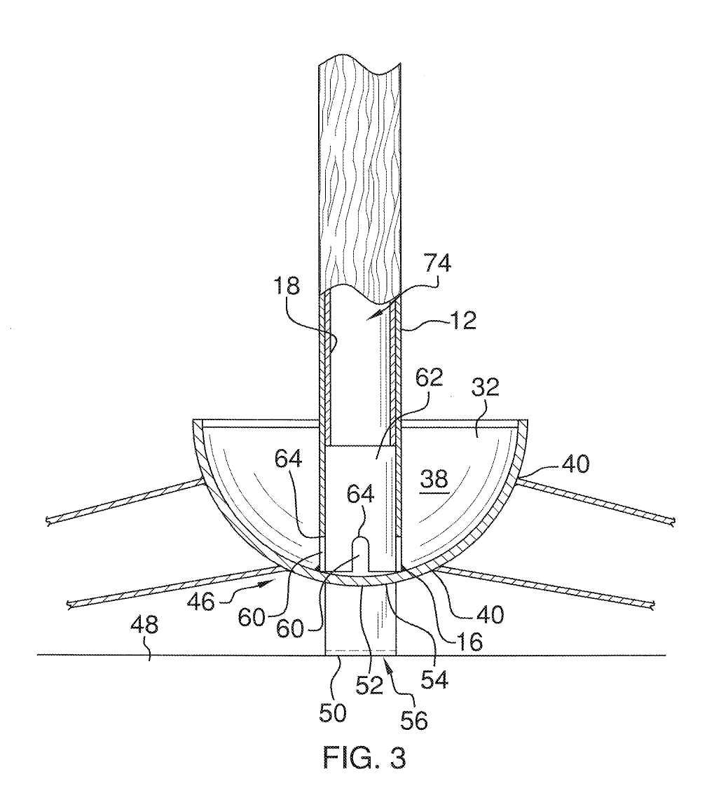

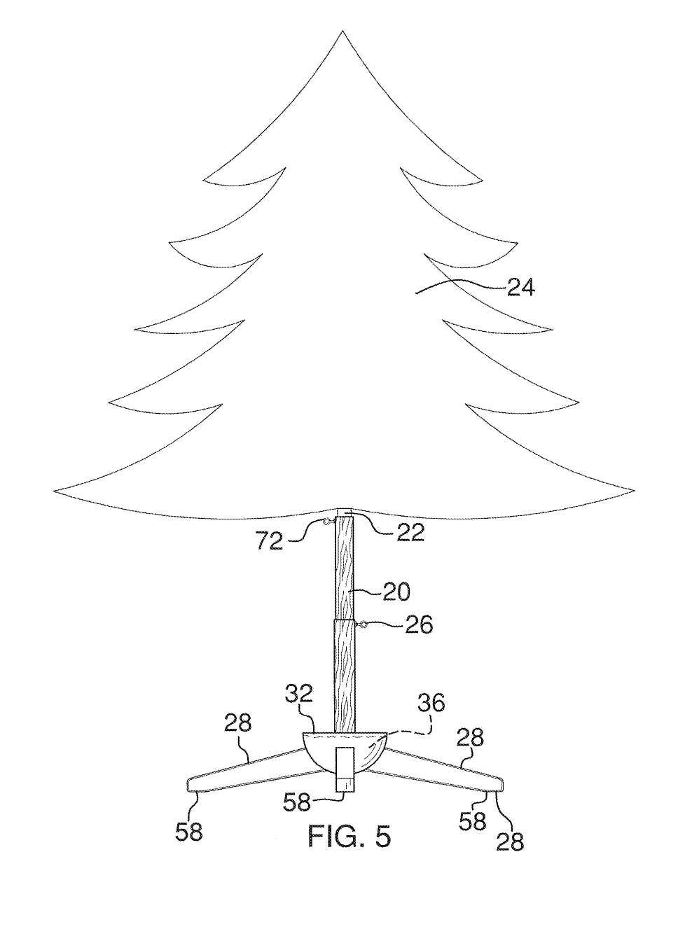

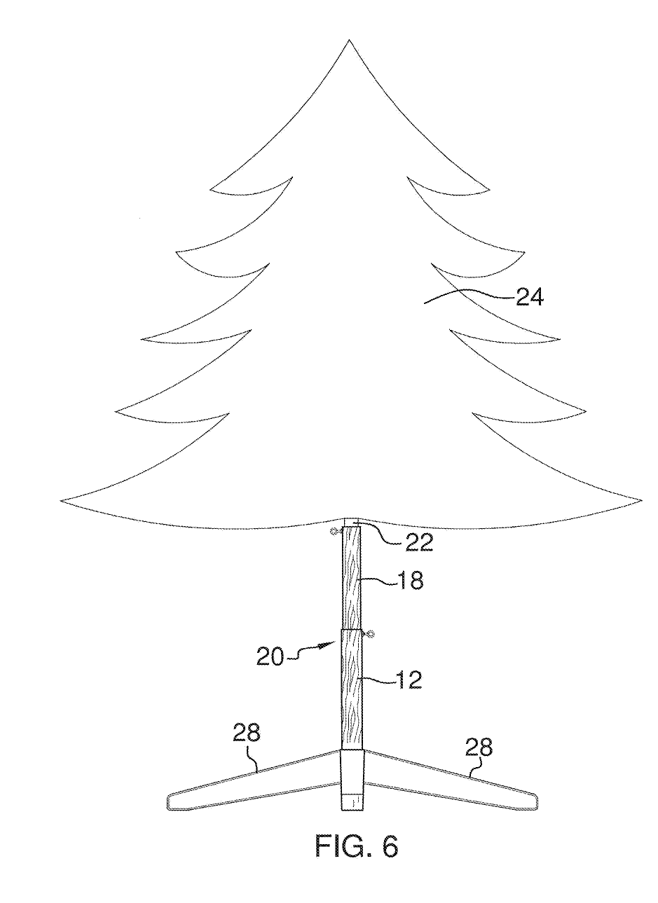

With reference now to the drawings, and in particular to FIGS. 1 through 6 thereof, a new stand device embodying the principles and concepts of an embodiment of the disclosure and generally designated by the reference numeral 10 will be described.

As best illustrated in FIGS. 1 through 6, the tree stand device 10 generally comprises a first sleeve 12 having a top end 14 and a bottom end 16. A second sleeve 18 is extendably nested in the first sleeve 12. The second sleeve 18 is extendable from the top end 14 of the first sleeve 16. The first sleeve 12 and the second sleeve 18 define a telescopically extendable tube 20 configured for receiving a trunk 22 of a tree 24. A locking member 26 such as a thumbscrew, nut, bolt, or the like, is coupled to the first sleeve 12. The locking member 26 selectively engages the second sleeve 18 wherein the second sleeve 18 is held in a static position relative to the first sleeve 12.

A plurality of legs 28 is coupled to and extends from first sleeve 12. The legs 28 are positioned proximate the bottom end 16 of the first sleeve 12 wherein the legs 28 support the tube 20 in an upright position 30 wherein the tree 24 is also supported in an upright position by the tube 20. A bowl 32 may be coupled to and extend upwardly around the bottom end 16 of the first sleeve 12 wherein the bowl 32 is configured for holding a liquid 36 adjacent to the bottom end 16 of the first sleeve 12 allowing for watering of a real cut tree. The bottom end 16 of the first sleeve 12 abuts a surface 38 of the bowl 32. Four apertures 60 may extend through the first sleeve 12 adjacent to the bottom end 16 of the first sleeve 12 wherein an interior space 62 of the first sleeve 12 is in fluid communication with the bowl 32. Each aperture 60 may be elongated and aligned with a longitudinal axis of the first sleeve 12. Each aperture 60 may also have an arched proximal end 64 relative to the top end 14 of the first sleeve 12. The apertures 60 may be radially arrange around the first sleeve 12.

Each of the legs 28 has a proximal end 40 relative to the tube 20 coupled to an outer surface 42 of the bowl 32. Each of the legs 28 extends radially outward from the bowl 32 away from the tube 20. Each of the legs 28 may further extend outwardly and downwardly from the bowl 32 such that the legs 28 support the bowl 32 in a raised position 46 relative to a supporting surface 48 upon which the legs 28 rest. A base 50 may be provided having a top end 52 coupled to and extending downwardly from a bottom 54 of the bowl 32. The base 50 may have a substantially planar bottom surface 56. The bottom surface 56 may be positioned coplanar with support surfaces 58 of each of the legs 28 wherein the base 50 is configured to support the bowl 32 on the supporting surface 48.

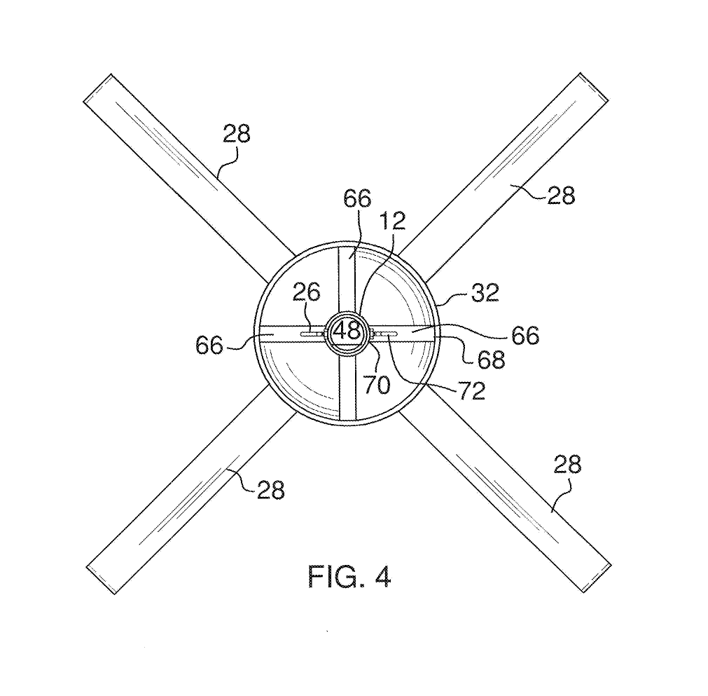

Each of a plurality of supports 66 has an outer end 68 coupled to the bowl 32 and an inner end 70 coupled to the first sleeve 12. Each support 66 may be positioned such that the support 66 extends radially outwardly relative to the tube 20 at a position bisecting an angle an adjacent pair of the legs 28 extends radially outward relative to the tube 20 as shown in FIG. 4.

A securing member 72 may be coupled to and extend through the second sleeve 18. The securing member 72 is adjustable to extend into an interior space 74 of the second sleeve 18 wherein the securing member 72 is configured for abutting and holding the trunk 22 of the tree 24 in a static position relative to the tube 20. An outer surface 76 of the first sleeve 12 and an outer surface 78 of the second sleeve 18 may each resemble an outer surface of a tree trunk to provide a natural consistent appearance with the trunk 22 of the tree 24 inserted into the tube 20.

In use, a synthetic or natural tree 24 is positioned in the tube 20 by insertion of the trunk 22 into the tube 20. The second sleeve 18 and first sleeve 12 are secured into a static position and to the tree 24 to hold the tree 24 upright. An embodiment with the bowl 32 may be employed with a natural tree 24 wherein water may be placed into the bowl 32 to prevent the natural tree 24 from drying out prematurely.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A tree stand device comprising:
a first sleeve having a top end and a bottom end;
a second sleeve extendably nested in said first sleeve, said second sleeve being extendable from said top end of said first sleeve, said first sleeve and said second sleeve defining a telescopically extendable tube configured for receiving a trunk of a tree;
a locking member coupled to said first sleeve, said locking member selectively engaging said second sleeve wherein said second sleeve is held in a static position relative to said first sleeve;
a plurality of legs coupled to and extending from first sleeve, said legs being positioned proximate said bottom end of said first sleeve wherein said legs support said tube in an upright position wherein the tree is supported in an upright position by said tube,

2. The device of claim 1, further comprising a bowl coupled to and extending upwardly around said bottom end of said first sleeve wherein said bowl is configured for holding a liquid adjacent to said bottom end of said first sleeve.

3. The device of claim 2, further comprising:
said bottom end of said sleeve abutting a surface of said bowl; and
at least one aperture extending through said first sleeve adjacent to said bottom end of said first sleeve wherein an interior space of said first sleeve is in fluid communication with said bowl.

4. The device of claim 2, further comprising a plurality of supports, each support having an outer end coupled to said bowl and an inner end coupled to said first sleeve.

5. The device of claim 2, further comprising each of said legs having a proximal end relative to said tube coupled to an outer surface of said bowl, each of said legs extending radially outward from said bowl away from said tube.

6. The device of claim 1, further comprising a securing member coupled to and extending through said second sleeve, said securing member being adjustable to said into an interior space of said second sleeve wherein said securing member is configured for abutting and holding the trunk of the tree in a static position relative to said tube.

7. The device of claim 3, further comprising said aperture being elongated and aligned with a longitudinal axis of said first sleeve.

8. The device of claim 7, further comprising said aperture having an arched proximal end relative to said top end of said first sleeve.

9. The device of claim 3, further comprising four said apertures, said apertures being radially arrange around said first sleeve.

10. The device of claim 1, further comprising an outer surface of said first sleeve and an outer surface of said second sleeve each resembling an outer surface of a trunk of a tree.

11. The device of claim 5, further comprising:
each of said legs extending outwardly and downwardly from said bowl wherein said legs support said bowl in a raised position relative to a supporting surface upon which said legs rest; and
a base having a top end coupled to and extending downwardly from a bottom of said bowl, said base having a substantially planar bottom surface, said bottom surface being coplanar with support surfaces of each of said legs wherein said base is configured to support said bowl on the supporting surface.

12. The device of claim 4, further comprising each support being positioned such that said support extends radially outwardly relative to said tube at a position bisecting an angle an adjacent pair of said legs extends radially outward from said tube.

13. A tree stand device comprising:
a first sleeve having a top end and a bottom end;
a second sleeve extendably nested in said first sleeve, said second sleeve being extendable from said top end of said first sleeve, said first sleeve and said second sleeve defining a telescopically extendable tube configured for receiving a trunk of a tree;
a locking member coupled to said first sleeve, said locking member selectively engaging said second sleeve wherein said second sleeve is held in a static position relative to said first sleeve;
a plurality of legs coupled to and extending from first sleeve, said legs being positioned proximate said bottom end of said first sleeve wherein said legs support said tube in an upright position wherein the tree is supported in an upright position by said tube;
a bowl coupled to and extending upwardly around said bottom end of said first sleeve wherein said bowl is configured for holding a liquid adjacent to said bottom end of said first sleeve, said bottom end of said sleeve abutting a surface of said bowl, each of said legs having a proximal end relative to said tube coupled to an outer surface of said bowl, each of said legs extending radially outward from said bowl away from said tube, each of said legs extending outwardly and downwardly from said bowl wherein said legs support said bowl in a raised position relative to a supporting surface upon which said legs rest;
a base having a top end coupled to and extending downwardly from a bottom of said bowl, said base having a substantially planar bottom surface, said bottom surface being coplanar with support surfaces of each of said legs wherein said base is configured to support said bowl on the supporting surface;
four apertures extending through said first sleeve adjacent to said bottom end of said first sleeve wherein an interior space of said first sleeve is in fluid communication with said bowl, each said aperture being elongated and aligned with a longitudinal axis of said first sleeve, each said aperture having an arched proximal end relative to said top end of said first sleeve, said apertures being radially arrange around said first sleeve;
a plurality of supports, each support having an outer end coupled to said bowl and an inner end coupled to said first sleeve, each support being positioned such that said support extends radially outwardly relative to said tube at a position bisecting an angle an adjacent pair of said legs extends radially outward relative to said tube;
a securing member coupled to and extending through said second sleeve, said securing member being adjustable to said into an interior space of said second sleeve wherein said securing member is configured for abutting and holding the trunk of the tree in a static position relative to said tube; and
an outer surface of said first sleeve and an outer surface of said second sleeve each resembling an outer surface of a trunk of a tree.
